(19) United States
(12) Patent Application Publication
(10) Pub. No.: US 2001/0003606 A1
(43) Pub. Date: Jun. 14, 2001

(54) METHOD FOR IMPROVING STABILITY OF ANTI-COATING LAYER

(76) Inventors: HUNG-YU KOU, TAIPEI HSIEN (TW); BRIAN WANG, TAOYUAN HSIEN (TW)

Correspondence Address: J C PATENTS INC, 1340 REYNOLDS AVENUE SUITE 114, IRVINE, CA, 92614

(21) Appl. No.: 09/325,365

(22) Filed: Jun. 4, 1999

(30) Foreign Application Priority Data
May 4, 1999 (TW) 88107217

(51) Int. Cl. H05H 1/24

(52) U.S. Cl. 427/569; 427/162

(57) ABSTRACT

A method for improving the stability of an anti-reflection coating layer is provided. The anti-reflection coating layer covered by a SiOₓN_{y} layer is provided. A surface treatment step is performed with an oxidizer-based plasma on the SiOₓN_{y} layer to form an oxide layer. The oxidizer-based plasma comprises O₂, and N₂O.

### BACKGROUND OF THE INVENTION

1. Field of the Invention

The present invention relates to a method for treating an anti-reflection coating (ARC) layer. More particularly, the present invention relates to a method for improving the stability of an ARC layer.

2. Description of the Related Art

Multilevel interconnections are used to connect metallic layers. The multilevel interconnections are utilized for the purpose of connecting the metallic layers in order to transfer signals. In order to prevent the metallic layers from making contact with each other, inter-metal dielectric layers are formed between the metallic layers. The multilevel interconnection fabrication process is complicated. Since a variety of steps, such as metallic sputtering, dielectric material deposition, or photolithography and etching are involved in the multilevel interconnection fabrication process, there are strict parameters for the performance of every step.

Additionally, materials of the inter-metal dielectric layer and the metallic layer affect exposure focus. In order to prevent the exposure focus from being affected by the reflected light from the metallic layer, an ARC layer, such as a SiOₓN_{y} layer, is formed on the metallic layer. The reflectivity of the ARC layer is very important since it greatly affects the exposure intensity and focus of the subsequent step.

Unfortunately, the reflectivity of the ARC layer decays with the passage of time. Thus, it is necessary to adjust constantly the parameters of the exposure step according to the decay of the ARC layer. This makes the exposure step cumbersome and slow.

To solve the decay problem of the ARC layer, the conventional method forms a cap layer on the ARC layer in order to reduce the decay rate of the reflectivity of the ARC layer. However, this causes difficulty in determining the thickness of the ARC layer. Since the thickness of the ARC layer also affects the reflectivity of the ARC layer, it is important to control the thickness of the ARC layer.

Reference is made to FIG. 1, which shows a comparison diagram of different decay rates for several ARC layers, each having different cap layers. In FIG. 1, SiOₓN_{y} is used as an exemplary ARC layer. A horizontal axis represents time, measured in hours. The vertical axis is reflectivity, measured as a percentage. The curve comprising black diamonds represents a SiOₓN_{y} layer with no cap layer covering. The curve comprising black triangles represents a SiOₓN_{y} layer covered by a cap layer having a thickness of 50 angstroms. The curve comprising black squares represents a SiOₓN_{y} layer covered by a cap layer having a thickness of 100 angstroms.

As shown in the diagram, the SiOₓN_{y} layer with no cap layer covering has a continuously decaying reflectivity, even after the second or the third day. Therefore, it is necessary to consider the decay of the SiOₓN_{y} layer while performing an exposure step. This, in turn, causes difficulty in determining the exposure parameters with consideration for decay of the SiOₓN_{y} layer.

In the conventional method, forming a cap layer covering a SiOₓN_{y} layer slightly reduces the decay of the SiOₓN_{y} layer. However it is difficult to control the thickness of the cap layer formed by, for example, thermal oxidation or other suitable steps, especially when the cap layer is required to be thinner than 100 angstroms. Thus, the conventional method is not optimal.

As shown in FIG. 1, the reflectivity of the SiOₓN_{y} layer covered by a cap layer that is about 50 angstroms thick, is about 1.1 times higher than the reflectivity of the SiOₓN_{y} layer covered by a cap layer that is about 100 angstroms thick. Therefore, if the thickness of the cap layer is not controlled, it is difficult to obtain a reflectivity of the SiOₓN_{y} layer. The quality SiOₓN_{y} layer cannot be ensured.

### SUMMARY OF THE INVENTION

The invention provides a method for improving stability of an anti-reflection coating (ARC) layer. An anti-reflection coating layer covered by a SiOₓN_{y} layer is provided. The SiOₓN_{y} layer comprises a plurality of dangling bonds. A surface treatment step with an oxidizer-based plasma on the SiOₓN_{y} layer is performed to bond completely the dangling bonds.

The present invention also provides a method of fabricating an anti-reflection coating layer. A surface treatment step with an oxidizer-based plasma is performed on a SiOₓN_{y} layer for about 2 seconds to form an oxide layer on the SiOₓN_{y} layer. The oxide layer is preferably about 50 angstroms thick.

In the invention, the oxidizer-based plasma preferably comprises O₂, N₂O, or a combination thereof.

The surface treatment step is an in-situ step. Thus, it is unnecessary to transfer the chip into another reaction chamber after the deposition of the SiOₓN_{y} layer. The plasma treatment step can be instantly performed on the ARC layer in the same reaction chamber.

Because the oxide layer is formed on the ARC layer, the thickness of the ARC layer does not changed with the passage of time. The reflectivity of the ARC layer does not changed as the time passes either. Therefore, there is no need to adjust constantly the exposure parameters while performing an exposure step on the dielectric layer over the ARC layer.

Moreover, since the surface treatment step does not provide any reactor, the invention forms the thin oxide layer by bonding the dangling bonds of the SiOₓN_{y} layer surface during the surface treatment step. Thus, the quality of the ARC layer is effectively controlled and the stability of the ARC layer is improved, as well.

It is to be understood that both the foregoing general description and the following detailed description are exemplary, and are intended to provide further explanation of the invention as claimed.

### BRIEF DESCRIPTION OF THE DRAWINGS

The accompanying drawing is included to provide a further understanding of the invention, and is incorporated in and constitutes a part of this specification. The drawing illustrate embodiments of the invention and, together with the description, serve to explain the principles of the invention. In the drawing,

FIG. 1 is a comparison diagram showing decays of several anti-reflection layers, each having a different cap layer formed thereon according to a conventional method;

FIG. 2 is a schematic diagram showing a molecular structure of a SiOₓN_{y} layer according to one preferred embodiment of the invention; and

FIG. 3 is a schematic diagram showing an oxide layer formed on a SiOₓN_{y} layer according to one preferred embodiment of the invention.

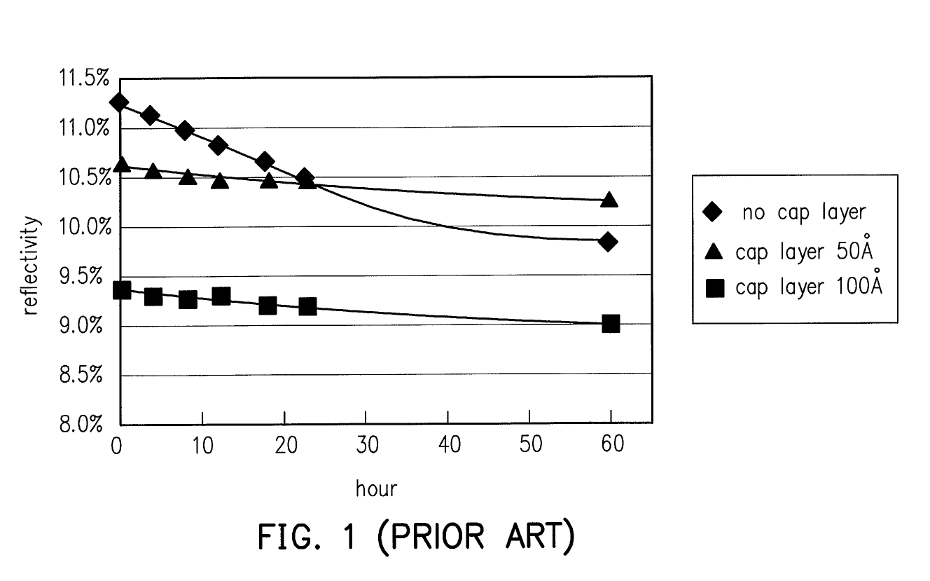

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Typically, an ARC layer is formed on a conductive layer. A dielectric layer is formed on the ARC layer. An exposure step is performed in the subsequent step in order to pattern the dielectric layer. In the exposure step, the ARC layer is used to decreases the light reflection.

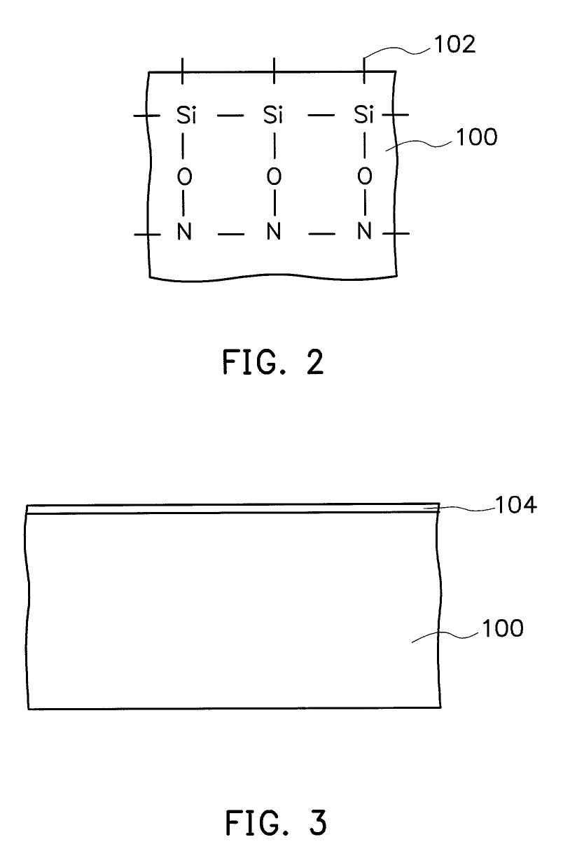

In the following preferred embodiment, the ARC layer is a single SiOₓN_{y} layer. However, the ARC layer can also be a stacked layer comprises a SiOₓN_{y} layer thereon. Reference is made to FIG. 2, which shows dangling bonds 102 of the SiOₓN_{y} layer 100. The dangling bonds 102 connect to Si atoms of the SiOₓN_{y} layer 100 and causes unstable SiOₓN_{y} layer 100. Commonly, this unstable SiOₓN_{y} layer 100 usually occurs on an ARC layer.

The present invention at least comprises performing a surface treatment step. The surface treatment step is preferably performed on the SiOₓN_{y} layer 100 with an oxidizer-based plasma, in order to bond completely the dangling bonds. The oxidizer-based plasma preferably comprises O₂, N₂O, or a combination thereof. The energy of the oxidizer-based plasma is preferably about 70 W.

In FIG. 3, the surface treatment step forms an oxide layer 104 having a thickness of about 50 angstroms on the SiOₓN_{y} layer 100. Such thickness is sufficient to bond completely the dangling bonds. The surface treatment is preferably performed for about 2 seconds with an environment pressure of about 2.5 Torr. According to experiment results, the thickness of the oxide layer 104 is almost the same at between about 2 seconds to about 10 seconds. As shown in FIG, 3, the preferred embodiment takes the SiOₓN_{y} layer 100 as the ARC layer for example. However, the ARC layer can also be a stacked layer, which at least comprises the SiOₓN_{y} layer 100 thereon.

The surface treatment step is an in-situ step. Thus, it is unnecessary to transfer the chip into another reaction chamber after the deposition of the SiOₓN_{y} layer 100. The plasma treatment step can be instantly performed on the ARC layer in the same reaction chamber.

In other words, the present invention provides an instant plasma treatment step to form the oxide layer 104 on the SiOₓN_{y} layer 100.

Because the oxide layer 104 is formed on the ARC layer, the thickness of the ARC layer does not changed with the passage of time. The reflectivity of the ARC layer does not changed as the time passes either. Therefore, there is no need to adjust constantly the exposure parameters while performing an exposure step on the dielectric layer over the ARC layer.

In the preferred embodiment, the surface treatment step does not provide any reactor. The present invention forms the thin oxide layer 104 only by bonding the dangling bonds of the SiOₓN_{y} layer 100 surface during the surface treatment step. Thus, the quality of the ARC layer is effectively controlled and the stability of the ARC layer is improved, as well.

It will be apparent to those skilled in the art that various modifications and variations can be made to the structure and the method of the present invention without departing from the scope or spirit of the invention. In view of the foregoing, it is intended that the present invention cover modifications and variations of this invention provided they fall within the scope of the following claims and their equivalents.

What is claimed is:

1. A method for improving stability of an anti-reflection coating layer, comprising:
providing an anti-reflection coating layer covered by a SiOₓN_{y} layer, wherein the SiOₓN_{y} layer comprises a plurality of dangling bonds; and
performing a surface treatment step with an oxidizer-based plasma on the SiOₓN_{y} layer to bond completely the dangling bonds.

2. The method of claim 1, wherein the surface treatment step is performed for about 2 seconds.

3. The method of claim 1, wherein the oxidizer-based plasma comprises O₂.

4. The method of claim 1, wherein the oxidizer-based plasma comprises N₂O.

5. A method for improving stability of an anti-reflection coating layer, comprising:
providing the anti-reflection coating layer covered by a SiOₓN_{y} layer, wherein the SiOₓN_{y} layer comprises a plurality of dangling bonds; and
performing a surface treatment step with an oxidizer-based plasma on the SiOₓN_{y} layer to form an oxide layer, wherein the thickness of the oxide layer is sufficient enough to bond completely the dangling bonds.

6. The method of claim 5, wherein the thickness of the oxide layer is about 50 angstroms.

7. The method of claim 5, wherein the oxidizer plasma comprises O₂.

8. The method of claim 5, wherein the oxidizer-based plasma comprises N₂O.

9. The method of claim 5, wherein the surface treatment step is performed for about 2 seconds.

10. A method of fabricating an anti-reflection coating layer, comprises:
providing a SiOₓN_{y} layer; and
performing a surface treatment step with an oxidizer-based plasma on the SiOₓN_{y} layer for about 2 seconds to form an oxide layer on the SiOₓN_{y} layer, wherein the oxide layer is about 50 angstroms thick.

11. The method of claim 10, wherein the oxidizer-based plasma comprises O₂.

12. The method of claim 10, wherein the oxidizer-based plasma comprises N₂O.
